(19) United States
(12) Patent Application Publication
(10) Pub. No.: US 2013/0282588 A1
(43) Pub. Date: Oct. 24, 2013

(54) Consumer, Merchant and Mobile Device Specific, Real-Time Dynamic Tokenization Activation within a Secure Mobile-Wallet Financial Transaction System

(71) Applicant: John Hruska, Stuart, FL (US)

(72) Inventor: John Hruska, Stuart, FL (US)

(21) Appl. No.: 13/452,913

(22) Filed: Apr. 22, 2012

(51) Int. Cl. G06Q 20/40; G06Q 20/32; G06Q 20/36; G06Q 20/10

(52) U.S. Cl. 705/67

(57) ABSTRACT

A secure system and method are disclosed to effectuate financial transactions over a secure internet backbone establishing and using a secure closed loop financial transactional system encompassing a proxy account and a pre-registered personal handheld mobile device to the account a preregistered merchant where all funds within the account remain in an “inactive” non-usable state until activated and allocated only by the consumer's registered mobile handheld device using a unique, time sensitive, device specific and merchant specific transactional token initially developed on the system's backend and subsequent token activation completion by the intended specific registered mobile device and by the intended merchant application.

### FIELD OF THE INVENTION

The present invention relates to a system and a method for secure financial transactions over a computer network, internet system and telecommunication network

### BACKGROUND OF THE INVENTION

Technological advances in hardware and software have enabled sophisticated computer hackers to exploit vulnerabilities of Point of Sale Systems, Automatic Teller Machines (ATMs), and Financial Server Systems allowing them to steal personal information, financial account numbers, credit card numbers, personal information including passwords and PIN numbers. Hackers' exploits range from database breaches, skimming devices to capture personal magnetic swipe information, information relating to key logging devices, accessing their accounts and draining cash through sophisticated exploits in financial databases. Today the increasing social and business trend is away from physical cash and towards paperless and electronic cash for myriad transactions in a digital environment. The system described below is applicable for securing transactions away from the prying eyes of hackers and keeping the consumer's personal information and financial instruments secure.

### SUMMARY OF THE INVENTION

The invention describes a secure mobile wallet financial transaction system by allowing users (both consumers and merchants) to set up a secure financial proxy account, and using registered mobile hand held devices (smartphone, non-smartphone and tablets) and proprietary applications that can securely transact payments either using a tablet or a mobile hand held device (smart phone) based POS, an automated teller machine (ATM) or an on-line checkout using secure proprietary applications for both consumers and merchants. Consumers using their pre-registered mobile device can transact business by having the backend mobile wallet system generate a unique consumer, merchant and device specific, single-use, time-sensitive, alpha-numeric inactive digital token and the transactional server encrypting these tokens with a consumer's personal public/private encryption key specific to the registered mobile device and its application; the user is able to activate and allocate a specific amount of funds from his pool of funds for a specific merchant and can be redeemed only by that specific merchant only after the inactive token becomes activated by the merchant's proprietary application as the last step in the activation loop before being sent to the backend transaction server.

The invention describes a consumer setting up a financial proxy account; a unique registration and authentication process of the consumer's mobile handheld device which has its own unique identifier (UDID) to the consumer's financial proxy account, a proprietary unique mobile application also having its own unique identifier (UAID) downloaded to the registered device, a registered merchant with a system assigned unique merchant identifier (UMID) along with a secure proprietary POS application containing the system assigned unique merchant identifier (UMID) on their device or website application used for their checkout shopping cart page, or within an ATM application. Using the consumer's registered mobile hand held device, a proprietary mobile phone application which is able to request and allocate those funds from their pooled account by initiating and receiving to the mobile application an inactive consumer and device specific, single-use, time-sensitive unique encrypted transactional digital token which is then appended by the application with both the UDID and UAID, a registered merchant's handheld wireless POS terminal (Tablet—POS) or a stationary wired device (ATM/Kiosk/POS) with the system's proprietary POS application software capable of recognizing, decoding and validating the inactive consumer and device specific, single-use, time-sensitive unique encrypted transactional digital token codes from the registered mobile device; the merchant proprietary application then appending the merchant specific id to the digital inactive token code to render the token active and subsequently encrypting the information with the system's public key for transmission to the backend transactional server. The back end transactional server able to decrypt the information which the merchant passes to the back end using the system's private key and approve/disapprove the transaction based on the transactional digital token information being active or not within the consumer's account providing a secure closed loop environment for secure transactional payment processing.

Similarly using the same financial-proxy system as described above a Merchant sets up a financial business proxy account providing all necessary personal and business identifying information. The system assigns a unique merchant identifier (UMID) to the merchant and subsequent to this is able to download the proprietary merchant application for their financial proxy account a system's point of sale application (POS) application to their telecommunication hand-held device, or through an application interface protocol (API) to their website for e-commerce transactions or to integrate this application into their existing POS system. The proprietary merchant application has the system assigned unique merchant identifier (UMID) within the application and appends the identifier information to the inactive digital tokens it receives from its consumers.

What is described is a secure mobile based financial proxy system, for both consumers and merchants using their registered handheld devices and proprietary applications developed for a closed-loop pooled financial proxy account which allows consumers to request and allocate to a specific amount of funds for a specific merchant which can only be redeemed by that specific merchant, while at the same time providing the security of a unique closed loop system using proprietary mobile phone and POS applications which recognize the system's uniquely generated and encrypted, consumer, mobile device and merchant specific digital transactional tokens to authenticate, validate and process the payment transaction securely. The system can also be used in an automated teller (ATM) setting and in an online transaction purchase setting obviating the need for an ATM card or the transmission of any personal information into the ATM or during an on-line purchase checkout shopping cart.

### BRIEF DESCRIPTION OF THE DRAWINGS

FIG. 1 shows Authentication, Log-in and Adding of Funds to a Customer's Virtual Account; Process Flow: Step 1

FIG. 2 shows the Activation and Allocation of Virtual Funds for a Specific Merchant Using a Time-Sensitive Dynamically Created Token; Process Flow: Step 2

FIG. 3 shows how a Merchant Opens up a Virtual Account and Downloads Proprietary Point-of-Sale App to Their Device; Process Flow: Step 3

FIG. 4 shows the Dynamic Token Activation through Merchant's Point-of-Sale App; Process Flow: Step 4

FIG. 5 shows the steps for Authentication and Creation of an Inactive Token for Allocation of Funds from Consumer's account using a pre-registered mobile hand held device

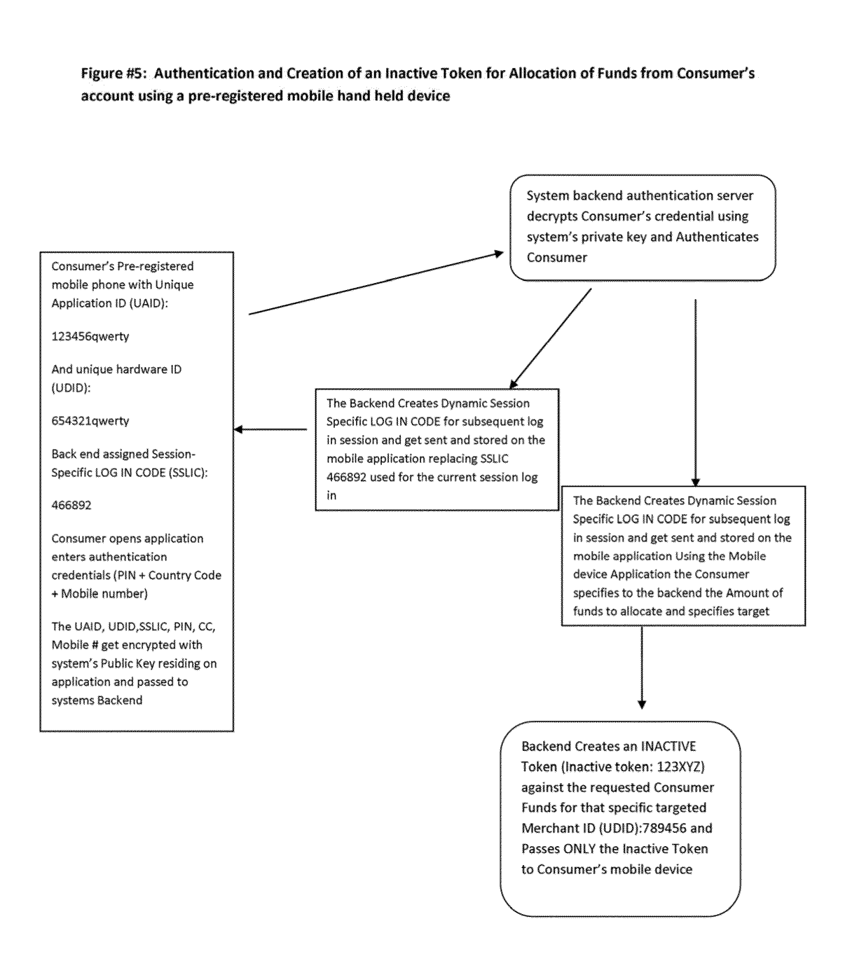

FIG. 6 shows how a Customer's Inactive Token is Activated for Specific Merchant

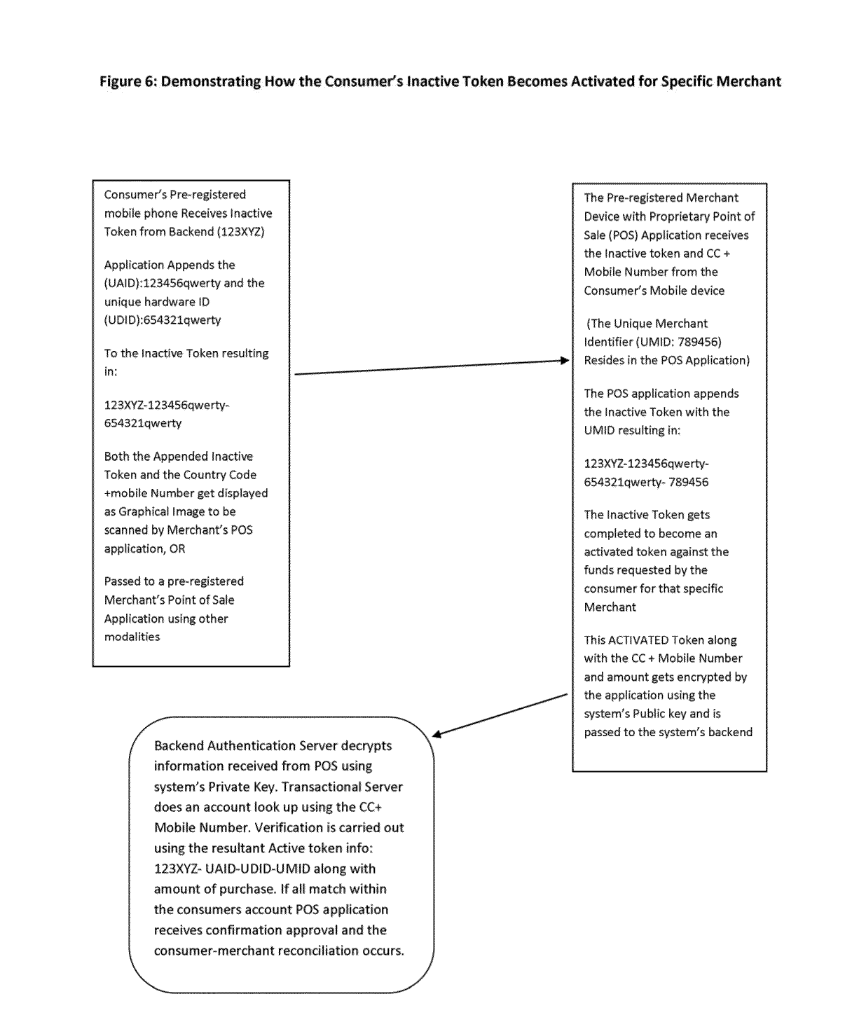

### DETAILED DESCRIPTION

### Step 1

### Account Set-Up

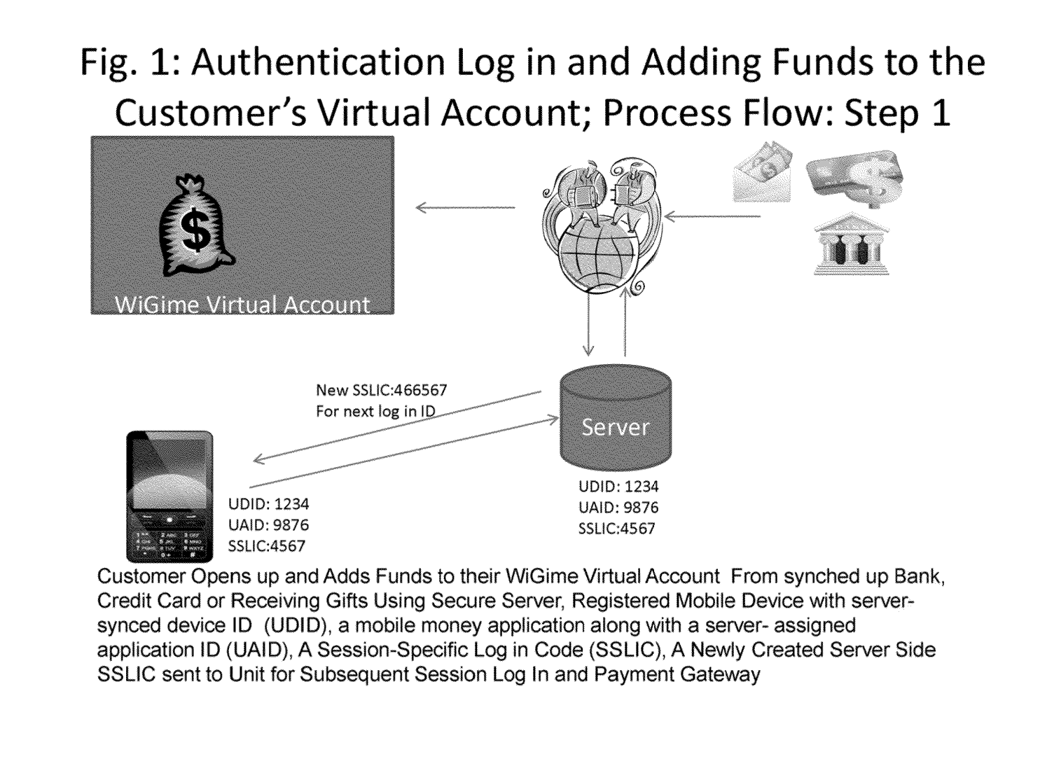

As shown in FIG. 1, Step 1, a customer establishes a secure proxy financial account with an electronically-based financial-type of institution or a mobile wallet system over a web-based mobile phone or web-based PC. After downloading the proprietary financial proxy account application the phone registration takes place; the consumer provides all necessary personal information including: name, address, creates a password, username, a personal identification (PIN) number. Optionally additional personal identifying biometric features using various phone feature modalities such as the camera for facial recognition, the microphone for voice spectral analysis and recognition and/or finger print reader device accessory built into some mobile handheld devices can also be used for consumer authentication. The application also obtains the mobile phone's unique device identifier (UDID) from the phone's hardware and is passed to the system's backend authentication server upon setup of the account. Just before completion of the account set up session the system's backend dynamically creates and assigns a Unique Application Identifier (UAID) to the application for that specific Unique Device Identifier (UDID) by the backend service which is stored both within the consumer's proprietary mobile device application and encrypted and stored on the system's backend authentication server using a one-way hashing technique. Once the data is collected, in the same session the mobile handheld device is registered and validated by having the system backend send to the mobile device a unique single-use time-sensitive authentication code developed by the back-end system and sent to the mobile through a separate channel (sms or voice). The authentication code is required to be entered during the application set up session and sent back to the authentication backend system server through the application to confirm and complete the account set up and mobile device registration process. At the completion of the mobile phone registration process the application receives and stores a dynamically generated session-specific log in authentication code assigned and stored by the backend. This session-specific code is required for session log in authentication. Once the session log in occurs the backend dynamically generates another session-specific log in code for that mobile application unit. This gets sent and stored on the application and is required for the subsequent session log in authentication. In addition an application specific public/private key pair also gets assigned to the handheld mobile device and its account and gets uploaded and stored on the mobile phone application to securely complete the account set up and phone registration process.

### Step 2

### Merchant Sign Up to System

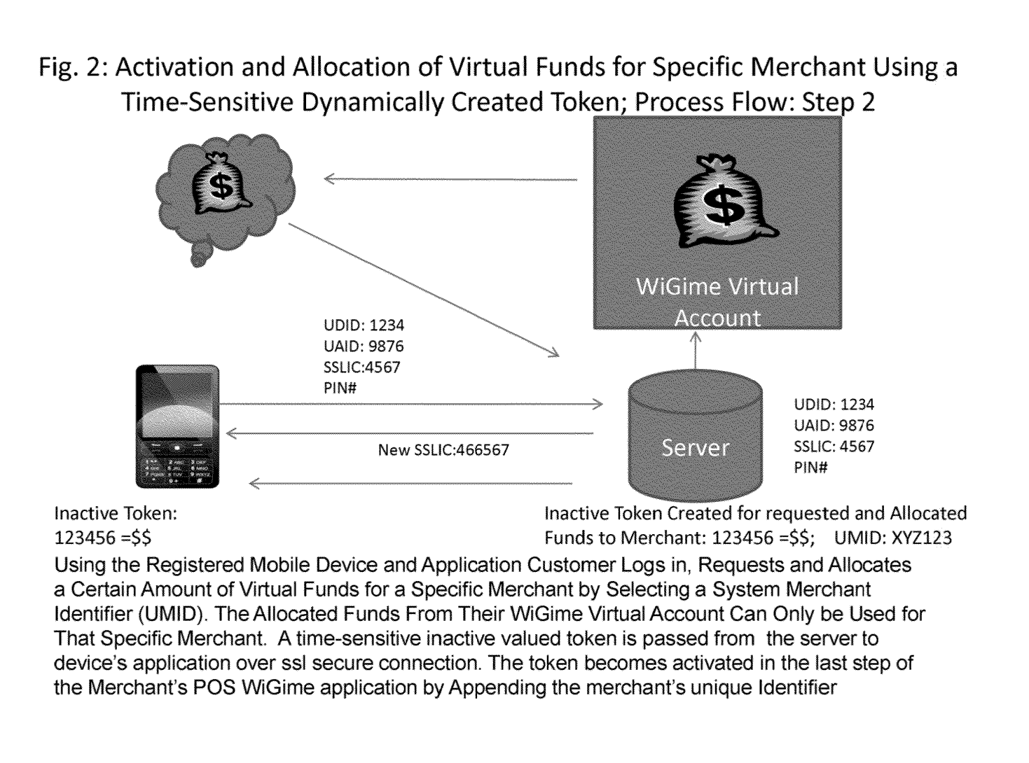

After downloading the proprietary point of sale application of the mobile wallet system to their tablet or mobile device using a web-session to sign up and open the account; a merchant provides all pertinent identifying information; the Information confirmed using the Business ID using tax ID# or some other types of business identification for verification methods provided by third party processors for anti-money-laundering prevention, as is depicted in FIG. 2, Step 2. During the account set up session the merchant provide tax ID information, business address, creates a Username, Password and Personal Identification Number (PIN). The application passes the devices UDID to the authentication server's backend. A system unique merchant ID (UMID) is dynamically generated by the authentication server for that specific merchant and is stored on the application for that specific merchant's device (mobile POS-mPOS) and is stored on the authentication server for that specific merchant's account. In addition, the system's public key resides within the merchant's POS application which is used to encrypt the token once it is received from the consumer and activated by the merchant pos application.

Once the account is set up and registration is complete, a Financial Proxy Account is created for the merchant, similar to the case of the consumer, to allow creation of, coding and decoding of the digital transaction tokens, validation and then passing to the system's backend authentication server for authentication and reconciliation processing between the merchant's financial proxy account and the consumer's financial proxy account using their respective registered mobile device and proprietary POS device or shopping cart applications.

### Step 3

### Using a Smart Phone Mobile Device Application to Allocate Funds

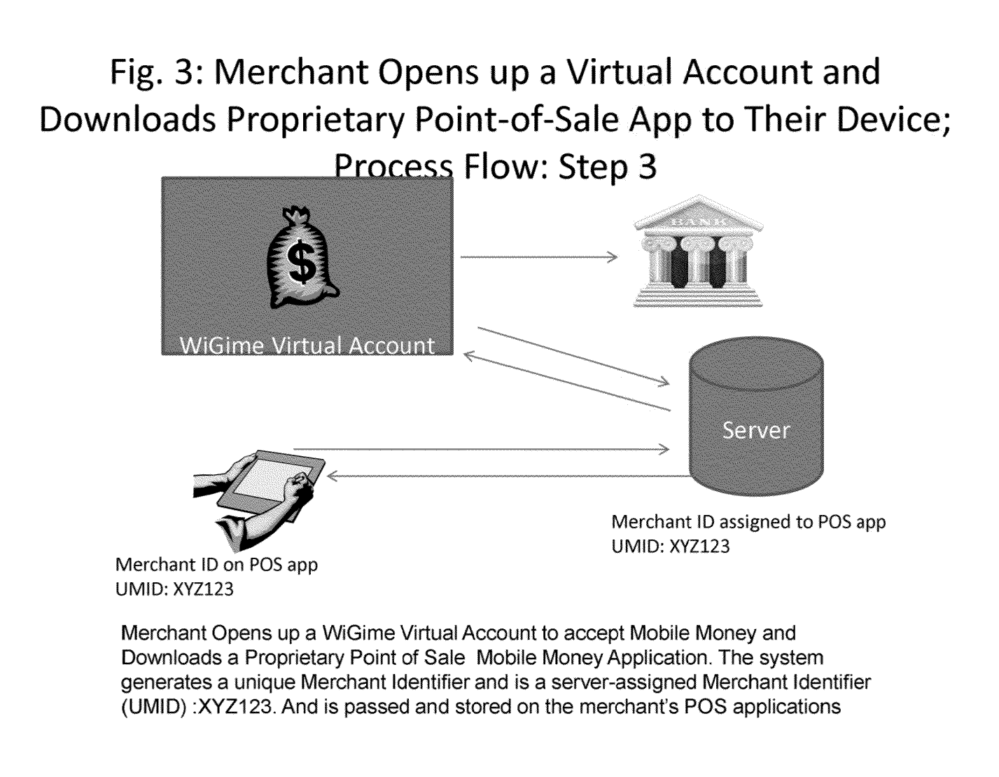

Using the mobile phone application, as shown in FIG. 3, Step 3, the user opens up the application inputs the mobile device's Country Code (CC), mobile phone number, and their personal identification number (PIN) through a graphical interface (GUI), optionally the application can also be capable of obtaining other biometric information such as voice or face recognitions or fingerprints to authenticate user. The following information (the PIN, the UDID, the Application ID; the country code (CC), mobile phone number, and the back-end assigned session-specific LOG IN Code gets encrypted using the backend system's public key from the mobile application. (Note: that the system's public key was initially assigned and downloaded to the application by the authentication server during initial consumer-account setup) The information gets encrypted with the system's public key and gets sent over ssl-256-bit encryption as a request from the consumer to the financial proxy account's authentication server. The authentication server side application validates the request by initially decrypting the information using the authentication server's private key and then looking up the account using the Country Code+mobile phone number. The authentication server uses the remaining decrypted information (the UDID, the UAID, The PIN and the session-specific log in code (SSLIC)) for authentication against the encrypted one-way hashed stored values within the consumer's proxy account: The user's personal information (PIN), the unique application identifier (UAID), the Unique Device Identifier number (UDID), and session-specific log in code (SSLIC) are all validated for authentication. Once the consumer log in is authenticated the backend immediately generates a session specific log in code (SSLIC) for that consumer's mobile application unit and gets sent and stored on the application for the subsequent log in, and also gets stored in the authentication server under the consumer's account for subsequent authentication. Next the consumer, through the application's GUI selects, the currency type, the specific amount of funds requested to be requested and allocated from their pool of inactive funds specific for that currency, and selects a specific merchant for which those funds are to redeemed, by selecting the merchant-specific identifier from a merchant list provided from the authentication server's backend. The transactional server verifies that the requested amount for the specific currency is available in the consumer's mobile financial proxy account and also verifies the merchant selected is actually active and is in good standing within the financial proxy system. Once confirmed, a random numeric or alphanumeric number is generated and used as an inactive time-sensitive single-use digital token against those funds requested by the consumer, which can only be redeemed by the intended merchant using the merchant's specific instance of the mobile-wallet point-of-sale application. The valued inactive token gets stored a one-way hashed encryption within the consumer's account representing the consumer's requested allocated funds for that specific merchant. The value token along with the funds it represents are time sensitive and remains in a temporarily inactive state until either being used by the consumer, or else timing out, in which case the funds merely remain within the consumer's account.

The inactive valued digital token gets transmitted to the mobile phone device application over a secure protocol (SSL) 256-bit encrypted channel. After obtaining the original valued inactive token the application appends the unique device identifier (UDID) taken from the device itself, and the unique application identifier (UAID) taken from the application itself in order to further complete the inactive digital valued token. This ensures the value added token was sent to the correct mobile unit device and the information required to further complete the digital valued token is obtained from the correct sources using the hardware UDID and software UAID ensuring these both were derived from their respective sources. This appended information further completes the token and without this addition of the appended data the token itself is useless and meaningless to the mobile wallet system and the funds cannot be utilized. The appended valued inactive token information along with the CC+ mobile device phone number (from within the application) gets displayed as a graphical representation (e.g. a QR code) which is generated on the mobile device itself by the application in preparation as one option of payment transfer.

### Step 4

### Secure Transactional Purchase

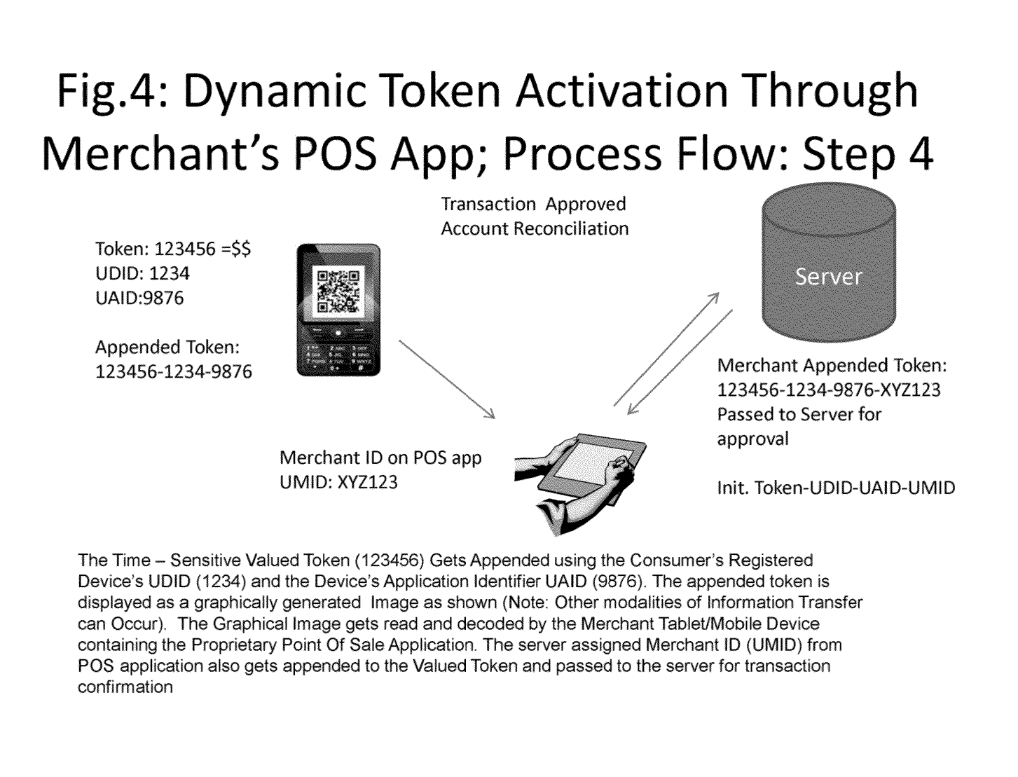

Using the Merchant's POS, ATM or Website shopping cart checkout containing the system's proprietary point of sale application the graphical image from the consumers mobile device gets scanned and decoded by the point of sale application, as in FIG. 4, Step 4, using one of several scanning modalities: one such modality being a CCD camera on the mobile device or tablet using the proprietary POS application to read and decode the graphical representation of the appended inactive digital valued token and country-code+mobile number from the consumer's mobile screen. Once scanned and decoded by the POS application, the application subsequently appends the unique merchant identifier (UMID) from that merchant's application (Note: this UMID was assigned to merchant application/device at the time of merchant account setup) to the inactive valued digital token that was passed from the consumer's mobile device. once the unique, time-sensitive, digital token is appended with the UMID it becomes an active valued token for the funds requested by the consumer specifically for that merchant, it gets encrypted by the POS application using the authentication server's backend public key. This resulting encrypted information is passed to the system's authentication server over ssl/tsl 256-bit encryption protocol for validation and processing. The authentication server using the backend server's private decryption key decrypts the unique, time-sensitive active digital token with the appended consumer and merchant information. Using the accompanying country-code+mobile cell phone number the backend does an account look up on the transactional server to confirm a valued digital token code exists within the consumer's account. Once this is confirmed, using the one way hashed encryption technique used on the receiving token and matched against the stored information on the server backend; the appended digital valued token data (the UDID, the UAID, the UMID and also the valued digital token itself must match to what is on file in the transactional server consumer's account to confirm transactional authentication in order for the valued digital token to be redeemed by the specific merchant and reconciliation of funds from the consumer's account to the merchant's account to take place. Once confirmed the activated funds are transacted in real time and the account is reconciled, thus debiting the consumer's proxy financial account and crediting the merchant's proxy financial account.

### Transaction Description Flow

### Automated Teller Machine or Financial Institution

A registered consumer activates their account using their pre-registered mobile phone and device application. After being authenticated, the consumer requests a certain amount of funds to be activated from their inactive funds, and similar to the merchant scenario, selects and specifies a specific ATM machine using a unique machine identifier assigned by and stored within the backend and within the ATM application. The consumer receives the device specific, ATM specific, unique time-sensitive, single-use encrypted digital token to their device. The mobile device application decrypts it with the applications private key, and appends the UAID and the UDID to the valued digital token and subsequently creates a graphical representation (e.g. a QR Code) of the data. The user selects the system's ATM financial proxy application to receive money from the unit. Using the ATM built-in CCD camera device (and mobile-wallet proprietary application), the consumer scans their valued token from the phone screen and the ATM-application decodes the barcode representation of the appended digital valued token. Similar to the “Transactional Description Flow for the POS above, the ATM application appends its own unique ATM machine identifier and subsequently encrypts the information using the backend system's public encryption key, then sends the information to the authentication server for processing. The authentication server decrypts and validates the information similar to the flow in Step 4 “Secure Transactional Purchase”. Once the transactional server verifies the active encrypted digital token code for the specified amount, it sends confirmation to the ATM to dispense correct amount. Funds get transferred and deducted from the consumer's account and credited to the ATM owner's financial proxy account along with associated fees if required.

I claim:

1. A system on a computer based network for secure transfer of a customer's funds to a merchant or financial institution, comprising:
a secure financial proxy account such as an online wallet, established for the purpose of holding unused dormant customer funds until activated and allocated by means of a pre-registered personal handheld device;
a personal handheld device of the customer;
a registration protocol for the personal handheld device;
a mobile application installed on the personal handheld device;
a unique device identification number for the personal handheld device;
a unique application identification number for the mobile application installed on that device;
a unique merchant identification number for the merchant or financial institution generated by the system upon their first registering on the system;
an activation and allocation protocol for identifying the account's registered handheld device, its mobile application and its owner for requesting that the account and funds be active and allocated for a particular desired transaction with a specific merchant or financial institution using the unique merchant identification number in a specified amount for a specific configurable amount of time;
a transactional and authentication server which stores and authenticates data sent from the customer's personal handheld device sent over a telecommunications network;
a session-specific log in code generated by the transactional and authentication server for the customer's personal handheld device and the mobile application installed on the personal handheld device when the customer logs in to the system which is stored both on the mobile application and on the transactional and authentication server for the purpose of authentication of the customer's subsequent log-in to the system under the customer's account;
a unique customer and device specific, merchant specific, time-sensitive, single-use encrypted digital transactional alphanumeric inactive token generated by the transactional and authentication server and sent to the handheld device, which is specific to the handheld device, it's application and the specified merchant identifier information for consummating the particular transaction with the specific merchant or financial institution;
and a graphical image generated on the personal handheld device, which expresses the unique customer and device specific, time-sensitive, single-use encrypted digital transactional alphanumeric inactive token upon receipt from the transactional and authentication server, appended to the unique device identification number for the personal handheld device and the unique application identification number for its installed mobile application, the image to be scanned by the merchant or financial institution to consummate the transaction;
wherein the unique merchant identification number, the unique device identification number and the unique application identification number are all stored on the transactional and authentication server for customer account authentication and fund activation.

2. The system of claim 1, further comprising:
a point of sale token scanner device to scan the graphically image expressing the unique customer and device specific, merchant specific, time-sensitive, single-use encrypted digital transactional alphanumeric inactive token appended to the unique device identification number for the personal handheld device and the unique application identification number for its installed mobile application; and
a linked proprietary merchant application used to parse out and validate the information from the unique customer and device specific, merchant specific, time-sensitive, single-use encrypted digital transactional alphanumeric inactive token appended to the unique device identification number for the personal handheld device and the unique application identification number and append this parsed information with specific merchant or financial institution information using the system generated unique merchant identification number, for validation of the combined token and identifier information at the transactional and authentication server.

3. The system of claim 1, where the personal handheld device is a telecommunication device with access to a telecommunication data network.

4. The system of claim 3, where the personal handheld device is a smartphone.

5. The system of claim 3, where the personal handheld device is a tablet device.

6. The system of claim 1, further comprising:
a front facing camera on the personal handheld device to take various industry-standardized facial measurements; and
a biometric validation application component which combines the facial measurements into the session-specific log in code for further security.

7. The system of claim 1, wherein the specific handheld device of the customer, and another telecommunication handheld or stationary device of the merchant or financial institution are enabled to communicate the graphical image using a near-field communication, Bluetooth, infrared, light transmission protocols, audible frequency, sms, mms, wi-fi or other suitable synchronizing protocol over a telecommunications network.

8. The system of claim 1, wherein:
the registration protocol for the personal handheld device comprises:
generating on the transactional and authentication server public and private encryption keys specific to the customer and the mobile device application; and
sending the public and private encryption keys to the personal handheld device and its mobile application; and
the activation protocol further comprises:
encryption by means of the mobile application the unique device identification number for the personal handheld device, the unique application identification number for the mobile application, as well as the session-specific log in code with the customer's assigned public key;
decryption of the unique device identification number for the personal handheld device, the unique application identification number for the mobile application, the session-specific log in code, as well as the desired transaction by the transactional and authentication server using the customer's assigned private key;
permanently hashing the results of the decryption by means of a one-way hash function;
and comparison of these decrypted hashed results to the stored data on the transactional and authentication server for the specific customer's account; and
the unique customer and device specific, merchant specific, time-sensitive, single-use encrypted digital transactional alphanumeric inactive token is encrypted by the transactional and authentication server using the customer's assigned public key, is sent over a secure telecommunication network to the personal handheld device, and is decrypted at the device using the user and device specific private key located on the mobile application.

9. A method for secure transfer of customer's funds, to a merchant or financial institution, comprising the steps of:
establishing an online account for a customer to hold dormant, unused funds for the customer;
linking the online account to a transactional and authentication server wherein an application resides to effectuate transfer of secure funds;
registering the customer's personal handheld device onto the server via an appropriate protocol;
generating a unique device identification number for the customer's personal handheld device and a unique application identification number for the mobile application installed on that device;
generating a unique merchant identification number for the merchant or financial institution by the system upon their first registering on the system;
logging in by the customer onto the system;
generating a session-specific log in code by the transactional and authentication server for the customer's personal handheld device and the mobile application installed on the personal handheld device after the customer logs in to the system;
storing of the session-specific log in code both on the mobile application and on the transactional and authentication server under the customer's account, for the purpose of authentication of the customer's subsequent log-in to the system;
verification of the consumer by means of the session-specific log in code generated by the transactional and authentication server for the consumer's personal handheld device and the mobile application installed on the personal handheld device generated on the customer's previous log in to the system which is;
identifying the account's registered personal handheld device and its associated customer for requesting the account and funds to be made active and allocated for a particular transaction with the specific merchant or financial institution;
activating and allocating funds in the online account for the customer via an appropriate protocol for the particular transaction with the specific merchant or financial institution in a specified amount for a specific configurable amount of time;
generating a unique user and device specific, time-sensitive, single-use encrypted digital transactional alphanumeric inactive token by the transactional and authentication server using the unique device identification number for the customer's personal handheld device, the unique application identification number for the mobile application installed on that device, and the unique merchant identification number for the merchant or financial institution, for the purpose of consummating the particular transaction with the specific merchant or financial institution;
transmitting the unique user and device specific, time-sensitive, single-use encrypted digital transactional alphanumeric inactive token by an ssl or tls or other secure protocol over a telecommunications network from the transactional and authentication server to the specific handheld device;
appending on the handheld device the unique customer and device specific, time-sensitive, single-use encrypted digital transactional alphanumeric inactive token received from the transactional and authentication server, with the unique device identification number for the personal handheld device and the unique application identification number for its installed mobile application;
generating on the personal handheld device a graphical image, to express the unique customer and device specific, time-sensitive, single-use encrypted digital transactional alphanumeric inactive token received from the transactional and authentication server, appended with the unique device identification number for the personal handheld device and the unique application identification number for its installed mobile application, the image to be scanned by the merchant or financial institution to consummate the transaction;
verifying the unique user and device specific, time-sensitive, single-use encrypted digital transactional alphanumeric inactive token, the unique device identification number for the customer's personal handheld device, the unique application identification number for the mobile application installed on that device, and the unique merchant identification number for the merchant or financial institution, by means of an appropriate secure transactional encryption and decryption algorithm on the transactional and authentication server.

10. The method of claim 9, further comprising the steps of:
scanning the graphical image expressing the unique customer and device specific, merchant specific, time-sensitive, single-use encrypted digital transactional alphanumeric inactive token appended to the unique device identification number for the personal handheld device and the unique application identification number for its installed mobile application by means of a point of sale token scanner at the specific merchant or financial institution;
parsing out and validating the unique customer and device specific, merchant specific, time-sensitive, single-use encrypted digital transactional alphanumeric inactive token, the unique device identification number for the personal handheld device, and the unique application identification number, by means of a linked proprietary merchant application;
combining the results generated in the parsing step information with specific merchant or financial institution information in the form of the system's unique merchant identification number, for validation of the combined token and identifier information at the transactional and authentication server, also by means of the linked proprietary merchant application;
transmitting the combined results of the unique user and device specific, time-sensitive, single-use encrypted digital transactional alphanumeric inactive token appended to the unique device identification number for the personal handheld device, the unique application identification number of its mobile application, and the unique merchant identification number, from the merchant or financial institution via a telecommunications network to the transactional and authentication server; and
identifying and validating the unique user and device specific, time-sensitive, single-use encrypted digital transactional alphanumeric inactive token appended to the unique device identification number for the personal handheld device, the unique application identification number of its mobile application, and the unique merchant identification number by the transactional and authentication server to consummate the customer's particular transaction with the merchant or financial institution.

11. The method of claim 9, further comprising the steps of:
taking various industry-standardized facial measurements by means of a front facing camera of the smart phone;
combining the facial measurements into the session-specific log in code for further security by means of a biometric validation application;
storing the results of the combination step in the users account;
passing the results of the combination step to the transactional and authentication server over the telecommunications network; and
utilizing the results of the combination step to biometrically validate and authenticate the user for a desired transaction.

12. The method of claim 9, wherein the personal handheld device is a telecommunication device with access to a telecommunication data network.

13. The method of claim 12, wherein the personal handheld device is a smartphone.

14. The method of claim 12, wherein the personal handheld device is a tablet device.

15. The method of claim 9, wherein the specific handheld device of the user, and another handheld or stationary device of the merchant or financial institution are enabled to communicate the graphical image using a near-field communication, Bluetooth, infrared, light transmission protocols, sms, mms, wi-fi or other suitable synchronizing protocol over a telecommunications network.

16. The method of claim 9, further comprising the steps of:
generating and assigning the customer with public and private encryption keys specific to the customer and the mobile device application;
encrypting by means of the mobile application on the handheld device the unique device identification number for the personal handheld device, the unique application identification number for the mobile application, the session-specific log in code, as well as the desired transaction by the transactional and authentication server using the customer's assigned private key prior to appending to the unique customer and device specific, time-sensitive, single-use encrypted digital transactional alphanumeric inactive token;
encrypting the unique customer and device specific, time-sensitive, single-use encrypted digital transactional alphanumeric inactive token by the transactional and authentication server using the customer's assigned public key prior to the transmission step;
decrypting the unique device identification number for the personal handheld device, the unique application identification number for the mobile application, the session-specific log in code, as well as the desired transaction by the transactional and authentication server using the customer's assigned private key prior to the verifying step on the transactional and authentication server;
decrypting after the transmission step the unique customer and device specific, time-sensitive, single-use encrypted digital transactional alphanumeric inactive token by the mobile application at the device using the user and device specific private key;
applying a one-way encryption hash function by the transactional and authentication server to the decryption results; and
comparing this information to the stored data on the transactional and authentication server in order to authenticate the specific customer's account.
